(19) United States
(12) Patent Application Publication
(10) Pub. No.: US 2005/0002553 A1
(43) Pub. Date: Jan. 6, 2005

(54) Image pattern recording method

(75) Inventor: Takao Ozaki, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/838,538

(22) Filed: May 5, 2004

(30) Foreign Application Priority Data
May 6, 2003 (JP) 127895/2003
Apr. 26, 2004 (JP) 129810/2004

(51) Int. Cl. G06K 9/00

(52) U.S. Cl. 382/141

(57) ABSTRACT

An image pattern recording method includes the steps of: recording medium supplying by a supplying device to supply a base plate; first measuring by a measuring device to measure the base plate; transferring by a transfer device to transfer the base plate from the measuring device to a recording device; second measuring on the base plate by the recording device; standard mark position obtaining by the recording device; image data correcting by the recording device; and recording by the recording device and the steps are carried out in this order. Further, the first measuring step is carried out on the next recording medium by the measuring device, which is supplied to the measuring device following the preceding recording medium in the recording medium supplying step, in parallel with one or a plurality of the second measuring step, the standard mark position obtaining step, the image data correcting step and the recording step on the preceding recording medium by the recording device.

### BACKGROUND OF THE INVENTION

1. Field of the Invention

The present invention relates to an image pattern recording method. Particularly, the present invention relates to an image pattern recording method including a measuring step for measuring a recording medium and a recording step for recording an image pattern on the recording medium using a result of the above-mentioned measuring step.

2. Description of the Related Art

An exposure device is known, wherein: a base plate or the like which is a recording medium is mounted on a base plate mount; the base plate is scanned by laser beams or the like in a direction orthogonal to a conveyance direction of the base plate while the base plate is carried in the above-mentioned conveyance direction; and an image pattern is recorded on the base plate. Another exposure device is also known, wherein: a position of a position measuring mark on a base plate, indicating a position of the base plate and a position of an image recording standard mark on the base plate, which is a standard position for exposure when an image pattern is exposed onto the base plate, are measured on the base plate mounted on a base plate mount; and an image pattern is accurately exposed onto the base plate mounted on the above-mentioned base plate mount based on the position information (for example, Japanese Unexamined Patent Publication No. 2000-338432).

Meanwhile, since very fine image patterns are exposed onto the base plate and high accuracy is required, there is a demand to expose the image patterns while also considering deformation of the base plate. To satisfy the demand, a method is being considered, wherein: a multiplicity of image recording standard marks is arranged on the base plate; and the image pattern is exposed onto the base plate at a more appropriate position on the base plate while considering the deformation of the base plate by accurately measuring positions of the image recording standard marks.

However, it requires a long time to accurately measure the multiplicity of image recording standard marks arranged on the base plate, and the image pattern may not be exposed onto the base plate during measurement of the above-mentioned image recording standard marks. Therefore, there is a problem that total productivity drops if the above-mentioned positions on the base plate are measured and the image patterns are exposed onto the base plate.

### SUMMARY OF THE INVENTION

In view of the foregoing circumstances, it is an object of the present invention to provide an image pattern recording method for preventing drop in total productivity during processing a plurality of recording media even if time expended for measuring a recording medium increases.

An image pattern recording method according to the present invention is an image pattern recording method for recording an image pattern on a recording medium having a position measuring mark, for measuring a position of the recording medium, and an image recording standard mark, which is a standard position for recording the image pattern when the image pattern is recorded on the recording medium, arranged thereon, the method comprising the steps of:
supplying the recording medium to a measuring device with a supplying device;
performing a first measurement with a measuring device to obtain positional relationship data indicating a positional relationship between a position of the position measuring mark and a position of the image recording standard mark on the recording medium supplied to the measuring device;
transferring the recording medium from the measuring device to a recording device with a transferring device;
performing a second measurement with the recording device to obtain position data representing a position of the position measuring mark on the recording medium, with respect to the recording device, transferred to the recording device;
obtaining a position of the image recording standard mark with respect to the recording device with the recording device, based on the positional relationship data obtained in the first measuring step and the position data obtained in the second measuring step;
correcting image data representing the image pattern with the recording device so that the image pattern is recorded on the recording medium based on the position of the image recording standard mark, obtained in the standard mark position obtaining step; and
recording an image pattern represented by the corrected image data on the recording medium with the recording device using the corrected image data. All of the steps are carried out in this order. Further, the first measurement by the measuring device is carried out on a next recording medium, which is supplied to the measuring device, following the preceding recording medium in the recording medium supplying step, in parallel with one or a plurality of the second measuring step, the standard mark position obtaining step, the image data correcting step and the recording step on the preceding recording medium by the recording device.

The position measuring mark for measuring the position of the aforementioned recording medium is a position measuring mark for indicating a position of the recording medium itself.

The aforementioned measuring device and the aforementioned transfer device may be connected by a vibration-isolator. A positional relationship between the measuring device and the transfer device may be fixed by prohibiting operation of the vibration-isolator when the recording medium is removed from the measuring device by the transfer device. The vibration-isolator may be actuated when the first measuring step is carried out by the measuring device. Further, the aforementioned transfer device and the aforementioned recording device may be connected by a vibration-isolator. A positional relationship between the transfer device and the recording device may be fixed by prohibiting operation of the vibration-isolator when the recording medium is transferred to the recording device by the transfer device. The aforementioned vibration-isolator may be actuated when the second measuring step or the recording step is carried out by the recording device.

The aforementioned vibration-isolator attenuates vibration that propagates between the devices through the vibration-isolator.

The aforementioned position measuring mark may also be used as the aforementioned image recording standard mark. All of the aforementioned position measuring marks may also be used as the aforementioned image recording standard marks. Alternatively, apart of the aforementioned position measuring marks may also be used as the aforementioned image recording standard marks.

It is preferable that the aforementioned recording medium includes a plurality of position measuring marks.

If the aforementioned recording medium has a shape of a polygon, corners of the above-mentioned polygon may be used as the aforementioned position measuring marks.

The image pattern recording method according to the present invention may further comprise the step of:
controlling each of a temperature of a table for holding the recording medium supplied to the measuring device and a temperature of a table for holding the recording medium transferred to the recording device to be constant.

In the image pattern recording method according to the present invention, the first measuring step is carried out by the measuring device on the next recording medium, which is supplied to the measuring device following the preceding recording medium, in the recording medium supplying step, in parallel with one or a plurality of the second measuring step, the standard mark position obtaining step, the image data correcting step and the recording step on the preceding recording medium by the recording device. Therefore, while the recording device is recording the image pattern on the recording medium, the measuring device may measure a position of the next recording medium following the above-mentioned preceding recording medium. Hence, drop in total productivity in processing a plurality of recording media is prevented even if time for measuring the above-mentioned position on a recording medium increases.

Conventionally, in processing the plurality of recording media, after the step of processing on a specific recording medium by the measuring device and the step of processing on the specific recording medium by the recording device ended, the step of processing on a next recording medium following the specific recording medium was carried out by the measuring device, and the step of processing on the next recording medium following the specific recording medium was carried out by the recording device. However, in the image pattern recording method according to the present invention, the steps of processing on the recording medium by the recording device may be carried out in parallel with the steps of processing on the next recording medium, following this recording medium, by the measuring device. Therefore, the total processing time can be shortened by time of the parallel processing as described above.

The measuring device and the transfer device may be connected by a vibration-isolator, a positional relationship between the measuring device and the transfer device may be fixed by prohibiting operation of the above-mentioned vibration-isolator when the recording medium is removed from the measuring device by the transfer device, and the vibration-isolator may be actuated when the first measuring step is carried out by the measuring device. Further, the transfer device and the recording device may be connected by a vibration-isolator, a positional relationship between the transfer device and the recording device may be fixed by prohibiting operation of the above-mentioned vibration-isolator when the recording medium is transferred onto the recording device by the transfer device, and the vibration-isolator may be actuated when the second measuring step or the recording step is carried out by the recording device. Consequently, when the above-mentioned first measuring step, second measuring step and recording step are carried out, influence of the vibration caused by movement of the transfer device or the like may be suppressed by actuating each of the vibration-isolators. Further, positional relationships among the measuring device, the transfer device and the recording device may be substantially fixed by prohibiting operation of each of the vibration-isolators when the base plate is transferred from the measuring device to the recording device by the transfer device. Therefore, the base plate can be transferred from the measuring device to the recording device so that a position of the recording medium with respect to the measuring device and a position of the transferred recording medium with respect to the recording device correspond to each other. If the recording medium is supplied to the measuring device so that the recording medium is positioned approximately at the same position with respect to the measuring device, the above-mentioned recording medium, i.e., position measuring mark on the recording medium, may be always positioned approximately at the same position with respect to the recording device, for example. Therefore, a load on the recording device in measuring may be reduced, which will be caused if the position of the position measuring mark is positioned at the end of a measuring range or outside of the measuring range when position data indicating the position of the position measuring mark are obtained in the above-mentioned second measuring step.

### BRIEF DESCRIPTION OF THE DRAWINGS

FIG. 1A shows the schematic structure of an image pattern recording device according to an embodiment of the present invention;

FIG. 1B shows the schematic structure of the image pattern recording device according to an embodiment of the present invention;

FIG. 2 illustrates position measuring marks and image recording standard marks on a base plate;

FIG. 3A shows the schematic structure of a supply stacker;

FIG. 3B shows the schematic structure of the supply stacker;

FIG. 4 shows a perspective view illustrating the schematic structure of a supplying device;

FIG. 5A shows a plan view illustrating how a base plate is positioned at a base plate supplying position by a positioning unit;

FIG. 5B shows a plan view illustrating how the base plate is positioned at the base plate supplying position by the positioning unit;

FIG. 5C shows a plan view illustrating how the base plate is positioned at the base plate supplying position by the positioning unit;

FIG. 6 shows a perspective view illustrating how the base plate is transferred to a measuring device by a transfer device;

FIG. 7 shows a perspective view illustrating the schematic structure of the measuring device;

FIG. 8 shows a perspective view illustrating the schematic structure of a measuring device, different from that of the measuring device illustrated in FIG. 7;

FIG. 9A shows a plan view illustrating the schematic structure of a measuring device, different from that of the measuring device illustrated in FIG. 7;

FIG. 9B shows a side view illustrating the schematic structure of the measuring device, different from that of the measuring device illustrated in FIG. 7;

FIG. 10 shows a side view illustrating how the base plate is transferred from the measuring device to a recording device by the transfer device;

FIG. 11A shows a plan view illustrating the structure of a base plate holder including pin holes for positioning;

FIG. 11B shows a side view illustrating the structure of the base plate holder including the pin holes for positioning;

FIG. 12A shows a side view illustrating how the base plate holder, including the pin holes for positioning, is positioned;

FIG. 12B shows a side view illustrating how the base plate holder, including the pin holes for positioning, is positioned;

FIG. 12C shows a side view illustrating how the base plate holder, including the pin holes for positioning, is positioned;

FIG. 13 shows a side view illustrating how the base plate is transferred to the recording device by the transfer device; and

FIG. 14 shows timing of processing on each base plate in each of the steps.

### DESCRIPTION OF THE PREFERRED EMBODIMENTS

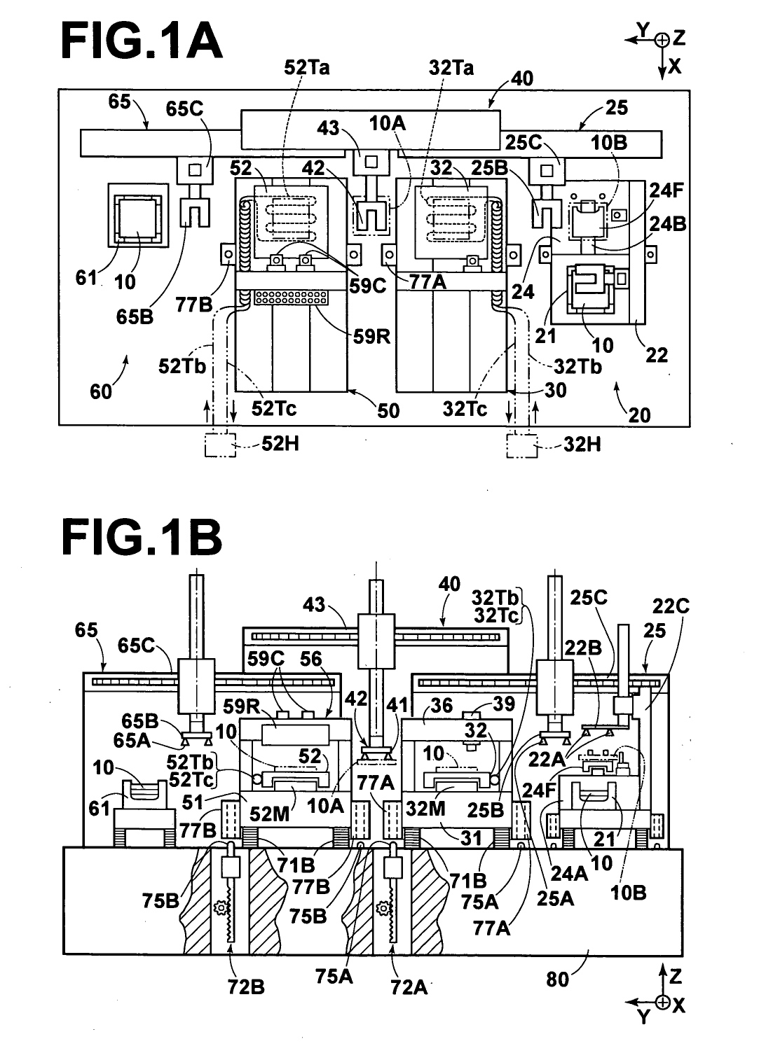

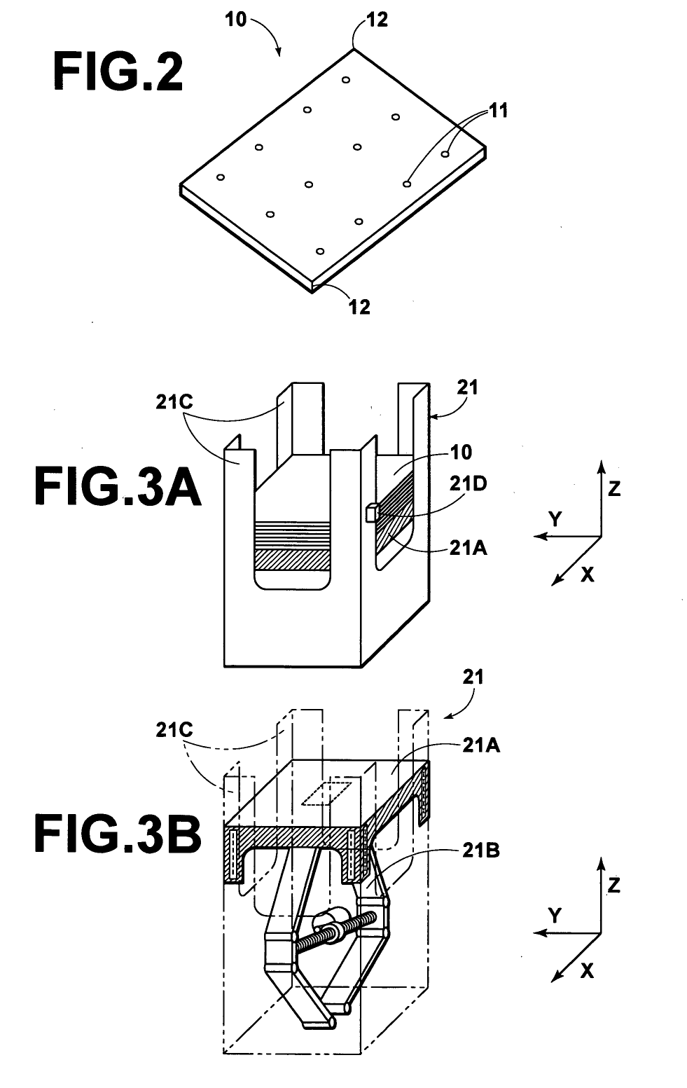

Hereinafter, embodiments of the present invention will be described with reference to the attached drawings. FIG. 1A shows the schematic structure of an image pattern recording device for carrying out an image pattern recording method according to the present invention. FIG. 1B shows a front view of the above-mentioned device. FIG. 2 illustrates position measuring marks and image recording standard marks on a base plate.

In the image pattern recording method according to the present invention, an image pattern is recorded on a recording medium having position measuring marks for indicating a position of the recording medium itself, i.e., position measuring marks for measuring the position of the recording medium, arranged thereon and image recording standard marks arranged thereon, which are used as standard positions for recording the image pattern when the image pattern is recorded.

An image pattern recording device for carrying out the above-mentioned image pattern recording method includes a supplying device 20, a measuring device 30, a transfer device 40, a recording device 50 and a retrieving device 60 as illustrated in FIGS. 1A and 1B.

The supplying device 20 includes a supply stacker 21 for storing a plurality of base plates 10 in a pile, a positioning unit 24 for positioning the base plates at predetermined base plate supplying position which has been determined in advance, a base plate transfer unit 22 for extracting the base plate 10 on the top of the pile in the supply stacker 21 and transferring the extracted base plate 10 to the positioning unit 24 and a transfer unit 25 for transferring the base plate 10 which has been positioned at the base plate supplying position by the positioning unit 24 to the measuring device 30.

As illustrated in FIG. 2, two corners located at different positions from each other on the base plate 10 in a square are used as position measuring marks 12. Image recording standard marks 11 in circles are arranged at 12 (3×4) positions on the base plate 10. The base plate 10 is a base plate for producing a print circuit board or the like including a photosensitive material layer, on which a wiring pattern is recorded.

The position measuring marks 12 may also be used as the image recording standard marks 11.

FIG. 3A shows a perspective view illustrating the schematic structure of the supply stacker. FIG. 3B shows a perspective view illustrating an internal structure of the supply stacker.

As illustrated in FIG. 3A and FIG. 3B, the supply stacker 21 includes a mount 21A for mounting a plurality of base plates 10 in a pile, a jacking unit 21B for automatically jacking up the position of the mount 21A every time when the base plate 10 on the top of the pile is extracted, so that a position of the base plate 10 on the top of the pile is always constant in the vertical direction (direction of arrow Z in FIGS. 3A and 3B) and a base plate holding unit 21C for regulating movement of the base plate 10 and the mount 21A in the longitudinal direction (direction of arrow X in FIGS. 3A and 3B) and the lateral direction (direction of arrow Y in FIGS. 3A and 3B) to guide edges of the base plate 10 and the mount 21A as well as housing the plurality of base plates 10 piled on the mount 21A. The position of the base plate 10 on the top of the pile housed in the base plate holding unit 21C is detected by a base plate presence sensor 21D which is a limit switch.

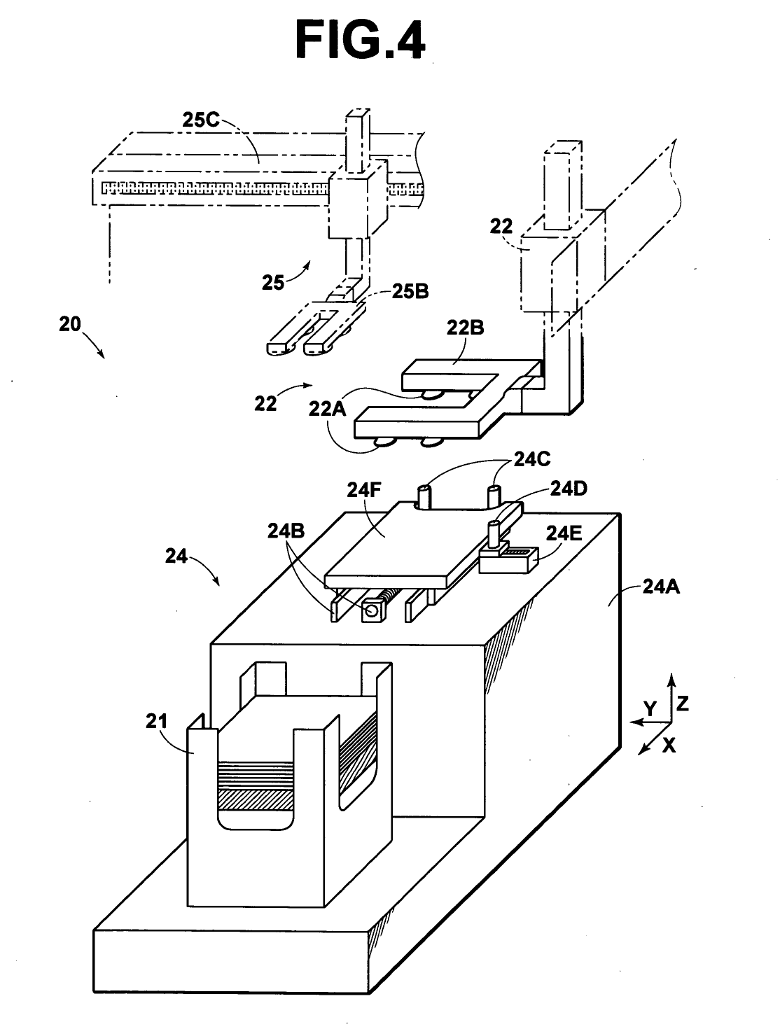

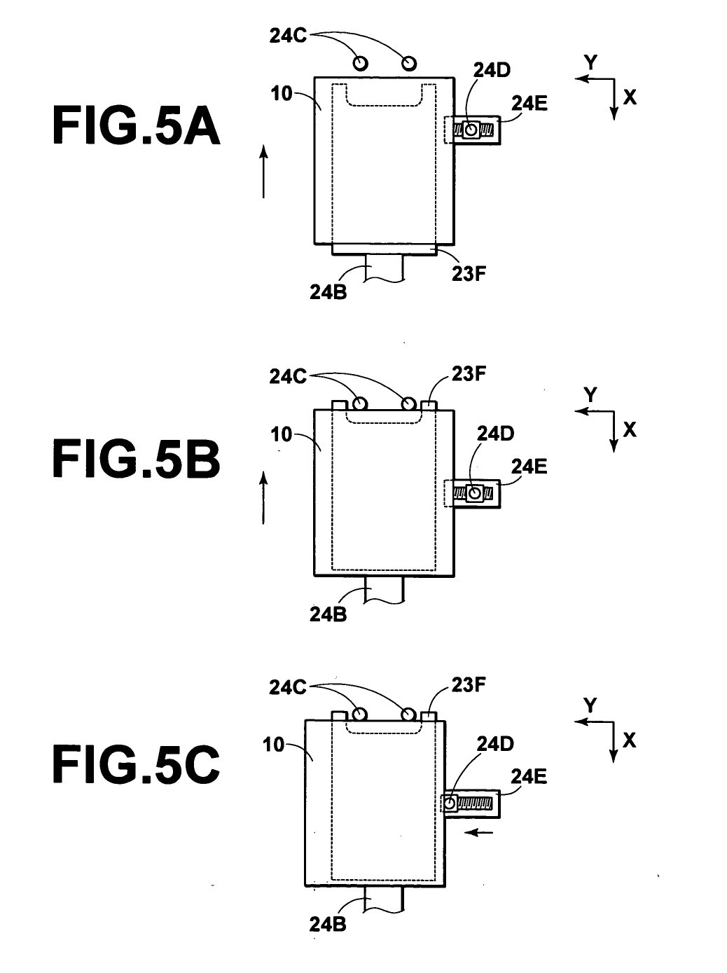

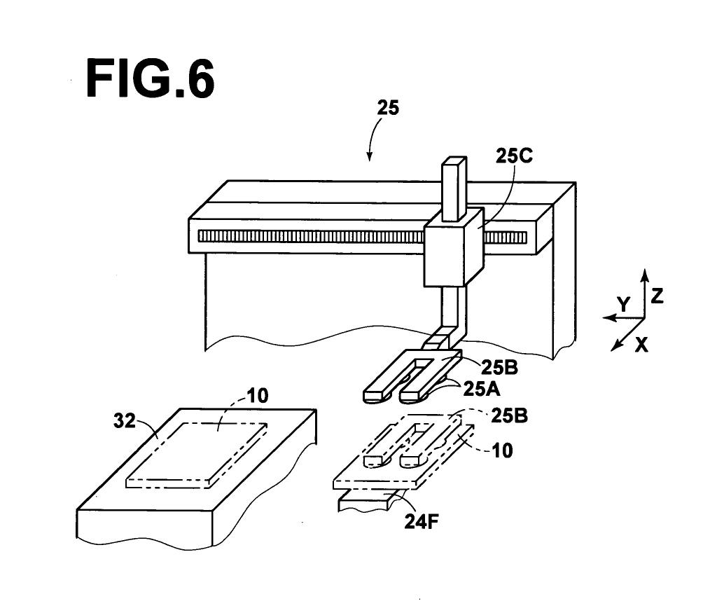

FIG. 4 shows a perspective view illustrating the schematic structure of the supplying device. FIGS. 5A-5C show plan views illustrating how the base plate is positioned at a base plate supplying position by the positioning unit. FIG. 6 shows a perspective view illustrating how the base plate is transferred to the measuring device by the transfer unit.

As illustrated in FIG. 4, the base plate transfer unit 22 of the supplying device 20 includes a base plate holder 22B having a suction unit 22A for suctioning the base plate 10 and a transfer unit 22C having movement axes of two-axes (X-axis and Z-axis) for transferring the base plate holder 22B. The base plate transfer unit 22 extracts the base plate 10 from the supply stacker 21 by suctioning the base plate 10 with the suction unit 22A and places the base plate 10 on the positioning unit 24.

The positioning unit 24 includes abase stage 24A, a table 24F on which the base plate 10 transferred by the base plate transfer unit 22 is mounted, a longitudinal drive unit 24B arranged on the base stage 24A, for supporting and moving the table 24F in the longitudinal direction (X direction), two longitudinal positioning pins 24C which are arranged on the base stage 24A and extending in the vertical direction and a lateral positioning pin moving unit 24E arranged on the base stage 24A, for moving a single lateral positioning pin 24D, which extends in the vertical direction, in the lateral direction.

The two longitudinal positioning pins 24C abut the base plate 10 (refer to FIG. 5A) in the longitudinal direction, which is mounted on the table 24F and transferred by being driven by the longitudinal drive unit 24B, to stop the movement of the base plate 10. Consequently, the base plate 10 is positioned in the longitudinal direction (refer to FIG. 5B). The lateral positioning pin moving unit 24E moves the single lateral positioning pin 24D in the lateral direction (direction Y). Then the above-mentioned longitudinal positioning pins 24C abut to the base plate 10 which has been positioned in the longitudinal direction and the position of the base plate 10 is moved in the lateral direction. Accordingly, the lateral positioning pin moving unit 24E determines the position of the base plate 10 in the lateral direction (refer to FIG. 5C). In this manner, the base plate 10 is positioned at the above-mentioned base plate supplying position.

Regarding the above-mentioned transfer unit 22C and longitudinal drive unit 24B and a base plate transfer unit 25C, the longitudinal drive unit 32M, the longitudinal-lateral drive unit 32KM, abase plate transfer unit 43, the longitudinal drive unit 52M, a base plate transfer unit 65C and the like which will be described later, a ball rail system or the like may be adopted as a movement mechanism and a rack-pinion mechanism, a ball screw/ball bush mechanism or a piston cylinder mechanism maybe adopted as a drive force transmission mechanism. A motor, a hydraulic actuator, a pneumatic actuator or the like may be adopted as a movement drive source.

As illustrated in FIG. 6, the transfer unit 25 includes a base plate holder 25B having a suction unit 25A for suctioning the base plate 10 and a base plate transfer unit 25C arranged on a common foundation stage 80 (refer to FIG. 1B), having movement axes of two-axes (Y-axis and Z-axis) for supporting and moving the base plate holder 25B. The transfer unit 25 places the base plate 10 on an X table of a measuring device 30 which will be described later by suctioning the base plate 10 placed on the table 24F of the positioning unit 24 with the suction unit 25A of the base plate holder 25B.

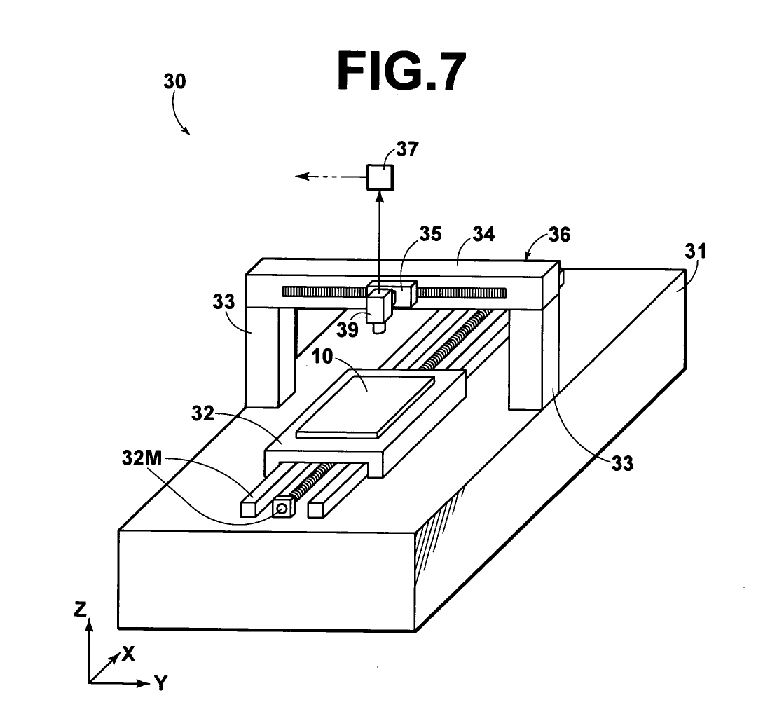

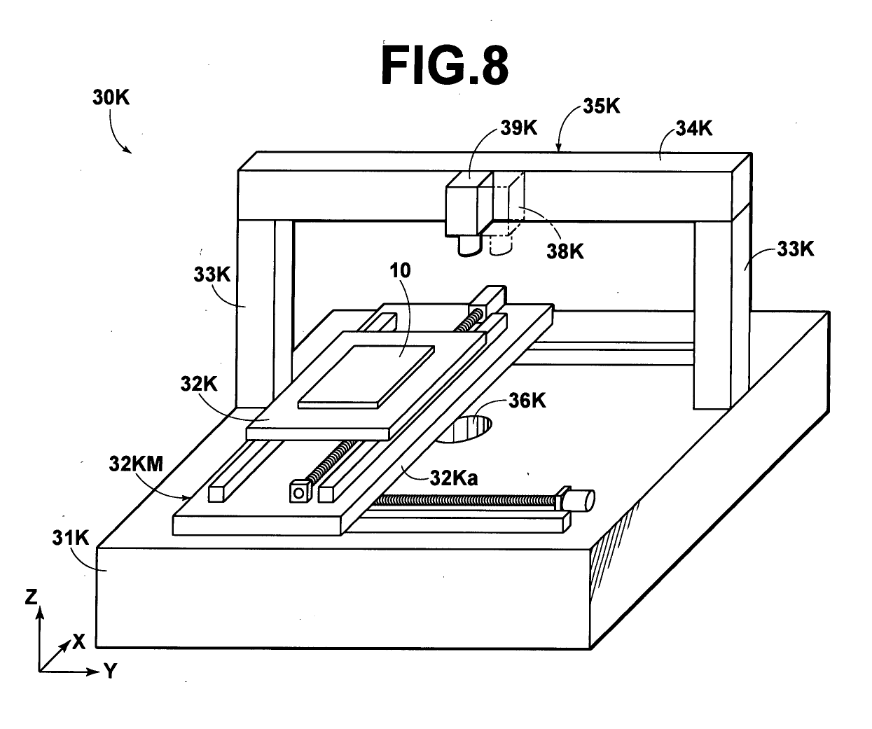

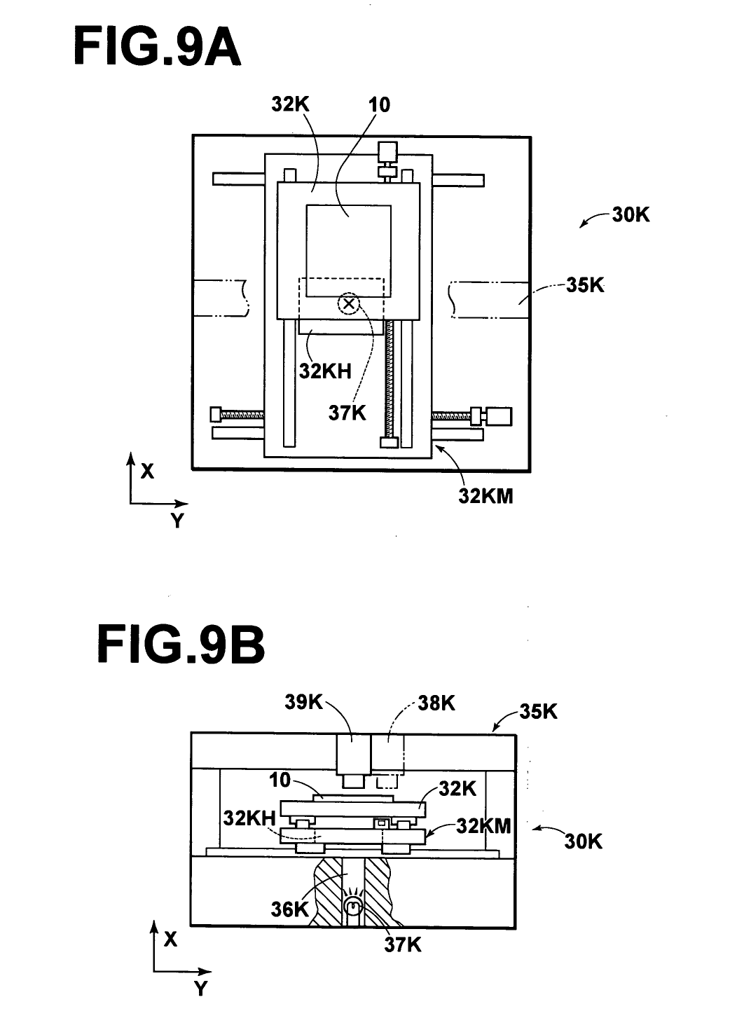

FIG. 7 shows a perspective view illustrating a measuring device. FIG. 8 shows a perspective view illustrating the schematic structure of a measuring device of which structure is different from that of the measuring device illustrated in FIG. 7. FIG. 9A shows a plan view illustrating the measuring device of FIG. 8. FIG. 9B shows a side view illustrating the measuring device of FIG. 8.

As illustrated in FIG. 7, the measuring device 30 includes a measuring base stage 31, an X table 32 on which the base plate 10 is mounted by the transfer unit 25, the longitudinal drive unit 32M arranged on the measuring base stage 31, for supporting and moving the X table 32 in the longitudinal direction (X direction), two posts 33 arranged on the measuring base stage 31 and a camera supporting unit 36. The camera supporting unit 36 has a gate form structure and includes a camera laterally-moving unit 34 for moving a moving stage 35 in the lateral direction, of which both edges are supported by the two posts 33. The measuring device 30 also includes a camera 39 arranged on the moving stage 35. The X table 32 is moved in the longitudinal direction while the camera 39 is moved back and forth in the lateral direction by the camera laterally-moving unit 34. The base plate 10 arranged on the X table 32 is measured with the camera 39.

The above-mentioned measuring device 30 further includes a positional relationship data obtaining unit 37 for measuring the base plate 10 mounted on the X table 32, with the camera 39 by moving the X table 32 in the longitudinal direction while moving the camera 39 back and forth in the lateral direction and obtaining and recording positional relationship data indicating a positional relationship between positions of the position measuring marks 12 (corners of the base plate 10) and positions of the image recording standard marks 11 arranged on the base plate 10.

Further, as illustrated in FIGS. 8, 9A and 9B, the above-mentioned measuring device may have a structure as will be described below. Specifically, a measuring device 30K may include a measuring base stage 31K having an opening 36K at the center, an XY table 32K for mounting the base plate 10 thereon, which can transmit X-ray, the longitudinal-lateral drive unit 32KM arranged on the measuring base stage 31K, for supporting the XY table 32K and moving the XY table 32K in the longitudinal direction (X direction) and the lateral direction (Y direction), two posts 33K arranged on the measuring base stage 31K and a camera holding unit 35K. The camera holding unit 35K may have a gate form structure and include a beam part 34K extending in the lateral direction, of which both edges are supported by the two posts 33K respectively. The measuring device may also include an X-ray detecting camera 39K for detecting X-ray, held by the beam part 34K of the camera holding unit 35K and an X-ray source 37K for irradiating the XY table 32K side with X-ray through the opening 36K, arranged at a lower part of the measuring base stage 31K. In this case, the measuring device detects the X-ray radiated from the X-ray source 37K and transmitted through the base plate 10 placed on the XY table 32K with the X-ray detecting camera 39K while the XY table 32K is moved in the longitudinal direction and the lateral direction. Consequently, the positions of the position measuring marks and the image recording standard marks on the base plate 10 are measured.

The beam part 34K may further hold a CCD camera 38K having sensitivity in a visible wavelength range next to the X-ray detecting camera 39K. The CCD camera 38K may read the positions of the position measuring marks on the base plate 10 while the XY table 32K is moved in the longitudinal direction and the lateral direction. The X-ray detecting camera 39K may read the positions of the image recording standard marks on the base plate 10 by detecting the X-ray which has been radiated from the X-ray source 37K and transmitted through the above-mentioned base plate 10 moving on the above-mentioned XY table 32K.

An opening 32KH is provided in the above-mentioned longitudinal-lateral drive unit 32KM so that the longitudinal-lateral drive unit 32KM does not block a propagation path of the above-mentioned X-ray which is radiated from the X-ray source 37K and incident on the X-ray detecting camera 39 when the XY table 32K is moved by the above-mentioned longitudinal-lateral drive unit 32KM in the longitudinal direction and the lateral direction.

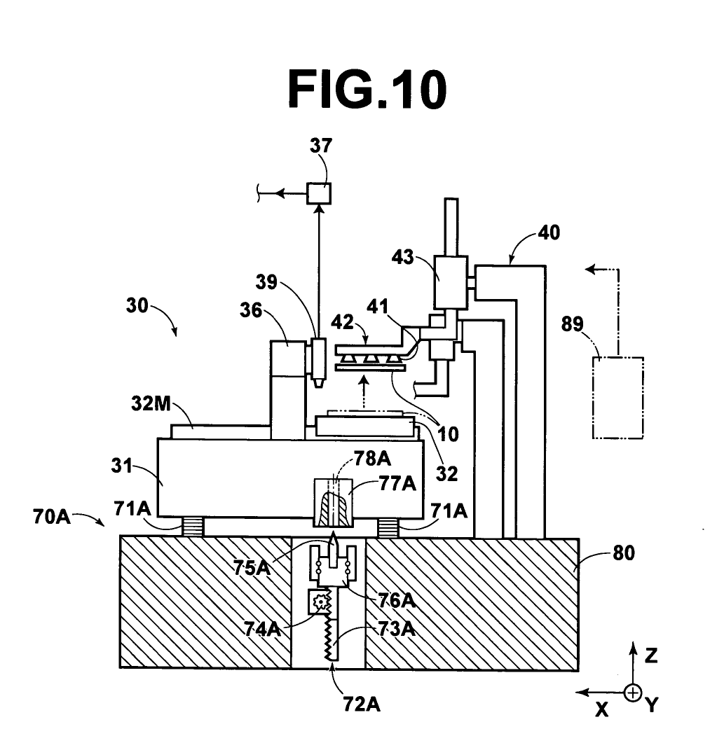

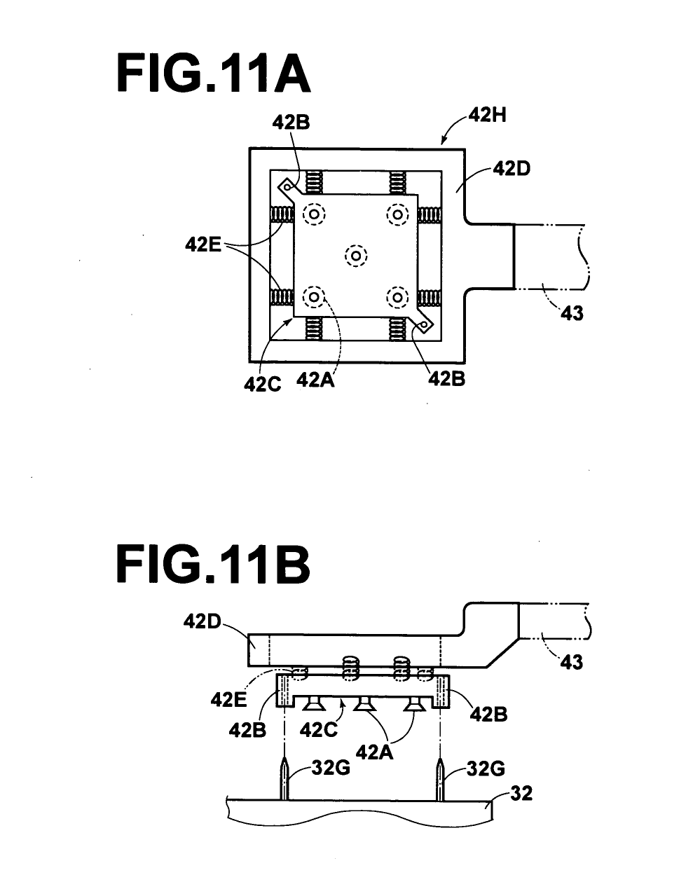

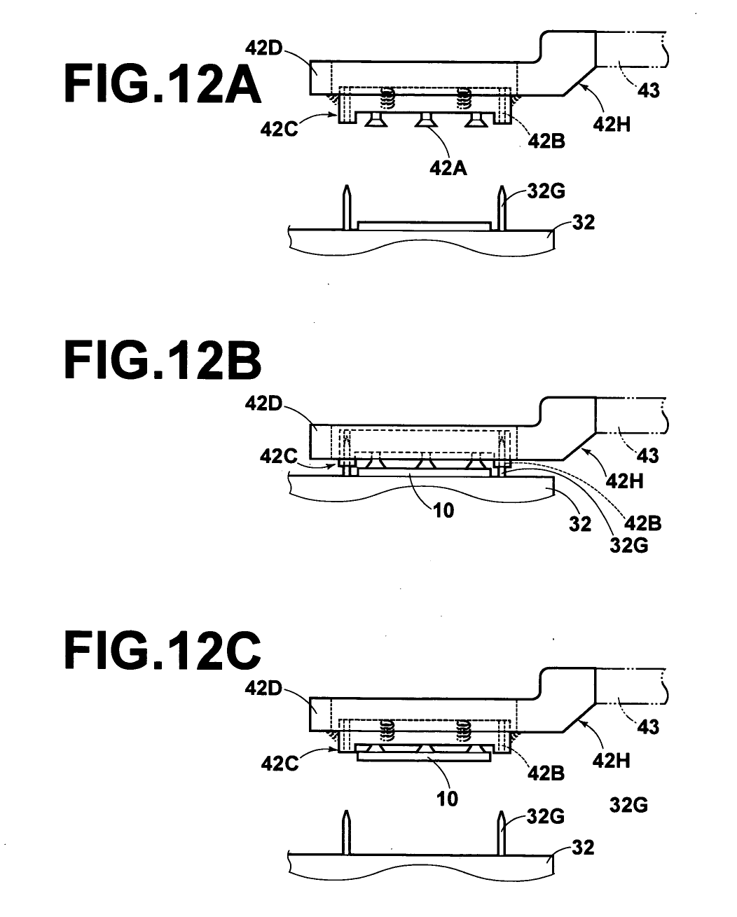

FIG. 10 shows a side view illustrating how the base plate is transferred from the measuring device to the recording device by the transfer device. FIG. 11A shows a plan view illustrating the structure of the base plate holder including pin holes for positioning. FIG. 11B shows a side view illustrating the above-mentioned base plate holder. FIGS. 12A, 12B and 12C show side views illustrating how the base plate holder including the pin holes for positioning is positioned and the base plate is suctioned.

As illustrated in FIG. 10, the transfer device 40 includes a base plate holder 42 having a suction unit 41 for suctioning the base plate 10 and the base plate transfer unit 43 arranged on the common foundation stage 80, having movement axes of two-axes (Y-axis and Z-axis), for supporting and moving the base plate holder 42. The transfer unit 40 suctions the base plate 10 placed on the measuring device 30 with the suction unit 41 and places the base plate 10 on the recording device 50.

The base plate holder or the like may have a structure as will be described below. The base plate holder or the like may transfer the base plate 10 placed on the measuring device 30 by suctioning.

Specifically, as illustrated in FIGS. 11A and 11B, a base plate holder 42H includes an internal holder unit 42C having pin holes 42B which are arranged on a diagonal line and extending in the vertical direction (Z direction) and suction units 42A arranged thereon. The base plate holder 42H also includes an external holder unit 42D having an opening for housing the internal holder unit 42C, which will be connected to the base plate transfer unit 43 and a plurality of springs 42E which are elastic elements for connecting the internal holder unit 42C and the external holder unit 42D. The base plate holder 42H is connected to the base plate transfer unit 43. Further, pins 32G extending in the vertical direction (Z direction) which will be fitted into the pin holes 42B of the above-mentioned base plate holder 42H are arranged on the X table 32 of the measuring device 30. Then, as illustrated in FIG. 12A, when the base plate holder 42H moves down toward the base plate 10 mounted on the X-table 32 by the drive of the base plate transfer unit 43, the pins 32G are fitted into the pin holes 42B of the internal holder unit 42C and the internal holder 42C is positioned in the longitudinal direction (X direction) and the lateral direction (Y direction). The base plate holder 42H moves further down and the suction unit 42A of the internal holder unit 42C suctions the base plate 10 (refer to FIG. 12B). Then, the base plate 10 suctioned by the suction unit 42A is moved up with the upward movement of the base plate holder 42H. The base plate 10 is moved up with the internal holder unit 42 while being suctioned by the suction unit 42A and the base plate 10 is transferred (refer to FIG. 12C). The base plate 10 placed on the measuring device 30 may be suctioned and transferred as described above.

The above-mentioned method may also be adopted to transfer the base plate from the supplying device 20 to the measuring device 30 and to transfer the base plate from the recording device 50 to the retrieving device 60.

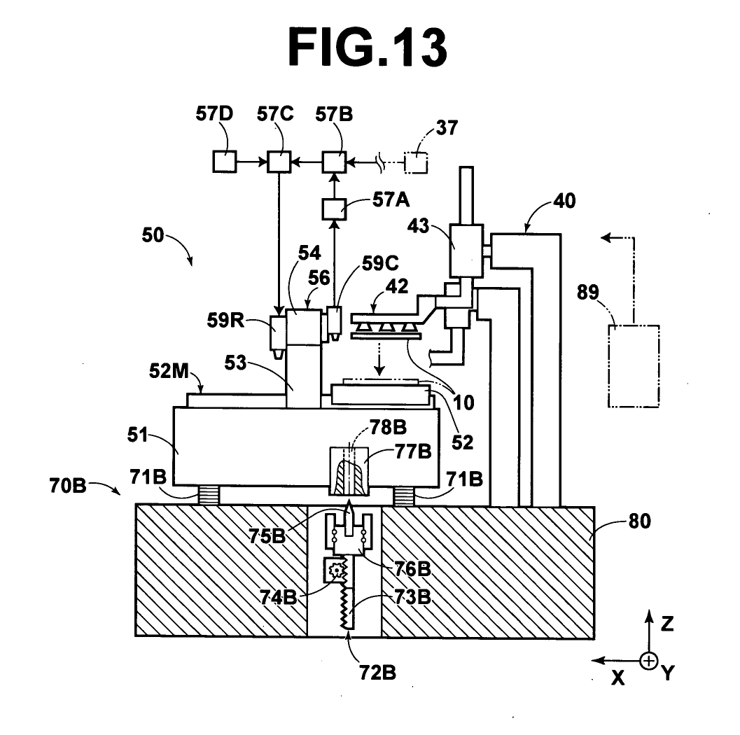

FIG. 13 shows a side view illustrating how the base plate is transferred to the recording device by the transfer device.

As illustrated in FIGS. 13, 1A and 1B, the recording device 50 includes a recording base stage 51, an X table 52 arranged on the recording base stage 51, which can move in the longitudinal direction, a longitudinal drive unit 52M for moving the X table 52 in the longitudinal direction, two posts 53 arranged on the recording base stage 51 and an exposure head supporting unit 56. The exposure head supporting unit 56 has a gate form structure and includes a beam part 54 extending in lateral direction, of which both edges are supported by the two posts 53. The recording device 50 also includes an exposure head 59R arranged on the beam part 54, for exposing a linear area extending in the lateral direction to light and two cameras 59C for measuring the base plate, arranged on a side of the beam part 54, which is opposite from the side on which the exposure head 59R is arranged.

The above-mentioned recording device 50 further includes a positional data obtaining unit 57A for obtaining positional data indicating positions of the position measuring marks 12 on the base plate 10 with respect to the recording device 50 by measuring the base plate 10 with the two cameras 59C, which is arranged on the X table 52 and transferred in the longitudinal direction by the X table 52. The recording device 50 also includes a standard mark position setting unit 57B for obtaining positions of the image recording standard marks 11 with respect to the recording device 50 based on the positional relationship data obtained by the above-mentioned positional relationship data obtaining unit 37 and the position data obtained by the above-mentioned position data obtaining unit 57A. The recording device 50 also includes an image data correcting unit 57C for correcting image data representing image pattern which are stored in an image data recording unit 57D in advance so that the image pattern is recorded on the base plate 10 based on the positions of the image recording standard marks 11 obtained by the standard mark position setting unit 57B. The exposure head 59R records the image pattern represented by the corrected image data on the base plate 10 by using the image data corrected by the image data correcting unit 57C.

Specifically, the image data representing the image pattern are corrected as will be described below.

First, the measuring device 30 measures positions of the two position measuring marks 12 on the base plate and positions of the 12 image recording standard marks 11 on the base plate 10 and obtains the positional relationship data. At this time, time for measuring is substantially same as the time for recording on the base plate 10 by the recording device 50.

Next, when the transfer device 40 transfers the base plate 10 from the measuring device 30 to the recording device 50, the recording device 50 measures the positions of the two position measuring marks 12 on the base plate with the cameras 59C for detecting the position of the base plate 10 mounted on the X table 52. Consequently, the positions of the position measuring marks 12 with respect to the recording device 50 are obtained. At this time, the two measurement positions are measured with the fixed cameras 59C, time for measuring is short.

Next, positions of the 12 image recording standard marks 11 on the base plate 10 mounted on the X table 52 of the recording device 50 with respect to the recording device 50 are obtained, by arithmetic operation of the standard mark position setting unit 57B based on the positions of the position measuring marks 12 with respect to the recording device 50, which have been obtained as described above, and the positional relationship between the above-mentioned image recording standard marks 11 and the position measuring marks 12, which has been already obtained by the measuring unit 30.

Next, the image pattern is recorded based on the positions of the image recording standard marks 11 with respect to the above-mentioned recording device 50, which have been obtained by the standard mark position setting unit 57B. Specifically, positions in the image pattern which will be exposed by the exposure head 59R of the recording device 50 are determined in advance to correspond to the positions of the image recording standard marks 11 on the base plate 10. The image pattern is recorded on the base plate 10 so that the predetermined positions in the image pattern correspond to the positions of the image recording standard marks 11 on the above-mentioned base plate 10 mounted on the X table 52 of the above-mentioned recording device 50. For that purpose, position coordinates of the image data representing the image pattern which will be exposed by the exposure head 59R are changed and a position of the image pattern exposed onto the base plate 10 is corrected. At this time, a position of the entire image pattern may be shifted or rotated. Alternatively, a magnification ratio, a shift amount and a rotation amount may be changed in each area of the image pattern.

Further, a rotation mechanism for rotating the base plate 10 mounted on the X table 52 of the recording device 50 may be added to the X table 52 to reduce the load of rotating an image by an arithmetic operation. Accordingly, the image pattern may be corrected in a rotation direction mechanically instead of by arithmetic operation.

The retrieving device 60 includes a retrieval stacker 61 for storing the plurality of base plates 10 in a pile and a transfer unit 65 for transferring the base plate 10 on the X table 52, which has been completely exposed to light by the recording device 50 to the retrieval stacker 61 as illustrated in FIGS. 1A and 1B.

The transfer unit 65 includes a base plate holder 65B having a suction unit 65A for suctioning the base plate 10 and abase plate transfer unit 65C arranged on the common foundation stage 80, having movement axes of two axes (Y axis and Z axis) for supporting and moving the base plate holder 65B. The transfer unit 65 suctions the base plate 10 arranged on the X table 52 of the recording device 50 with the suction unit 65A and places the base plate 10 on the top of the pile of the base plates 10 in the retrieval stacker 61.

Here, a vibration-isolating mechanism in the measuring device 30 and the recording device 50 will be described. The base plate transfer unit 43 of the transfer device 40 is arranged on the common foundation stage 80. The measuring base stage 31 of the measuring device 30 is arranged on the common foundation stage 80 through a vibration-isolating unit 70A (refer to FIGS. 10, 1A and 1B). Meanwhile, the recording base stage 51 of the recording device 50 is arranged on the common foundation stage 80 through a vibration-isolating unit 70B (refer to FIGS. 13, 1A and 1B).

The vibration-isolating unit 70A includes vibration-isolators 71A arranged at four corners on the bottom of the measuring base stage 31 of the measuring device 30, for connecting the measuring device 30 and the transfer device 40 and a switching unit 72A for switching the operation states of the vibration-isolators 71A by actuating or prohibiting the operation the vibration-isolators 71A. When the switching unit 72A prohibits the operation of the vibration-isolators 71A, the positional relationship (positional relationships in the longitudinal direction and the lateral direction) between the measuring device 30 and the transfer device 40 is fixed.

The switching unit 72A includes a linear mechanism or the like for moving a pin 75A along a slide guide 76A in the Z direction and the linear mechanism is arranged on the common foundation stage 80. The switching unit 72A fixes the positional relationship between the above-mentioned measuring device 30 and the above-mentioned transfer device 40 by inserting the pin 75A into a pin hole 78A in a pin hole receiving unit 77A arranged on the measuring base stage 31 and fitting the pin 75A into the pin hole 78A. The switching unit 72A includes a drive mechanism having a rack 73A to which the pin 75A is connected, a pinion 74A which is engaged with the rack 73A, a motor (not illustrated) for rotating the pinion 74A and the like. The switching unit 72A moves the pin 75A along the slide guide 76A in the Z direction.

Meanwhile, the vibration-isolating unit 70B includes vibration-isolators 71B mounted at four corners on the bottom of the recording base stage 51 of the recording device 50, for connecting the transfer device 40 and the recording device 50 and a switching unit 72B having the same function as the above-mentioned switching unit 72A. If the switching unit 72B prohibits operation of the vibration-isolator 71B, the positional relationship (positional relationship in the longitudinal direction and the lateral direction) between the recording device 50 and the transfer device 40 is fixed.

The switching unit 72B includes a linear mechanism or the like for moving a pin 75B along the slide guide 76B in the Z direction. The linear mechanism is arranged on the common foundation stage 80 in the same manner as the above-mentioned switching unit 72A. The switching unit 72B fixes the above-mentioned positional relationship between the recording device 50 and the transfer device 40 by inserting the pin 75B into the pin hole 78B in the pin hole receiving unit 77B arranged on the recording base stage 51 and fitting the pin 75B into the pin hole 78B. The switching unit 72B includes a drive mechanism having a rack 73B to which the pin 75B is connected, a pinion 74B engaged with the rack 73B, a motor (not illustrated) for rotating the pinion 74B and the like. The switching unit 72B moves the pin 75B along the slide guide 76B in the Z direction.

An elastic element such as rubber, a coil spring and a leaf spring or an elasticity production system such as an air spring may be used as the vibration-isolator 71A and the vibration-isolator 71B.

Next, with reference to FIG. 1, a temperature control mechanism for maintaining each of a temperature of the X table 32 provided in the measuring device 30 and a temperature of the X table 52 provided in the recording device 50 to be constant will be described.

The temperature of the X table 32 of the measuring device 30 is controlled to be constant by circulating a liquid, of which temperature is controlled to be constant, in an embedded pipe 32Ta formed in the X table 32. The liquid, which will be circulated in the embedded pipe 32Ta, is supplied from a chiller 32H to the embedded pipe 32Ta through a pipe 32Tb, which is drawn through the X table 32. The liquid is returned from the embedded pipe 32Ta to the chiller 32H through a pipe 32Tc which is drawn through the X table 32.

The temperature of the X table 52 of the recording device 50 is controlled in the same manner as that of the X table 32. The temperature of the X table 52 is controlled to be constant by circulating a liquid, of which temperature is controlled to be constant, in an embedded pipe 52Ta formed in the X table 52. The liquid, which will be circulated in the embedded pipe 52Ta, is supplied from a chiller 52H to the embedded pipe 52Ta through a pipe 52Tb which is drawn through the X table 52. The liquid is returned from the embedded pipe 52Ta to the chiller 52H through a pipe 52Tc, which is drawn through the X table 52.

The temperature of the X table 32 of the measuring device 30 and the temperature of the X table 52 of the recording device 50 may be controlled to be equal. The temperatures may also be controlled to be slightly different from each other.

A controller 89 controls a whole operation and timing of each operation of the above-mentioned devices.

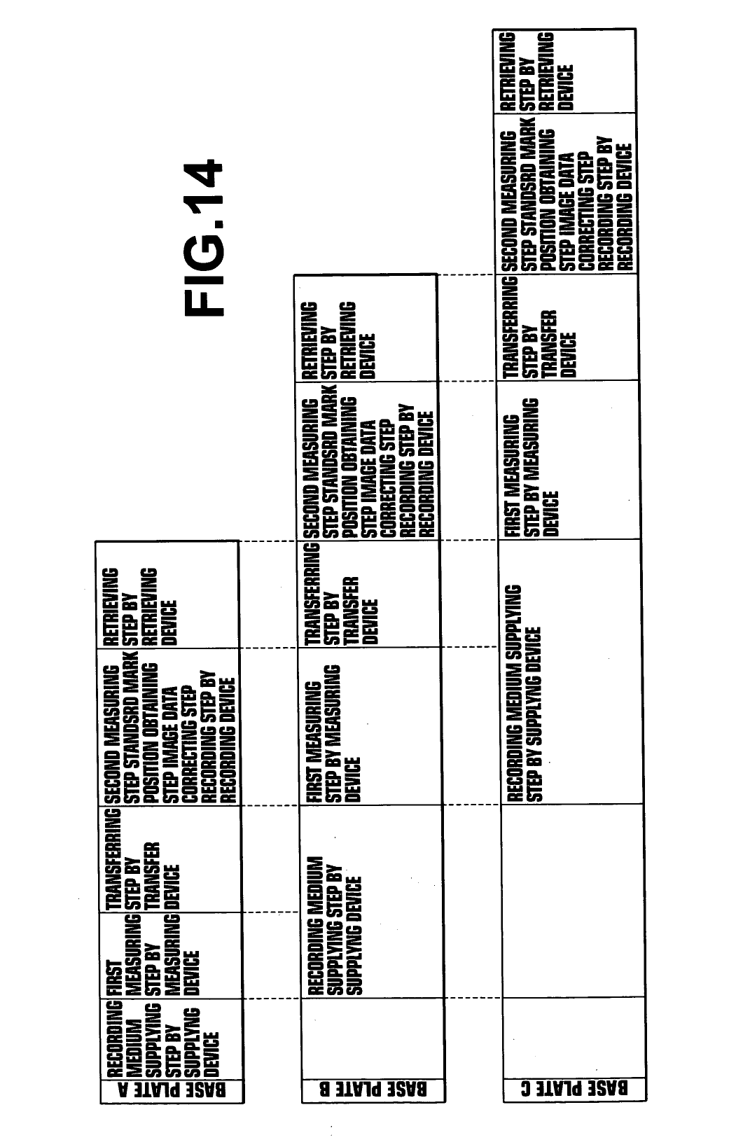

Operation of the image pattern recording device based on the image pattern recording method will be described with reference to FIG. 14. FIG. 14 shows timing of processing on each base plate in each of the steps.

In the following description on the image pattern recording device, a base plate 10A, a base plate 10B and a base plate 10C are supplied to each device in this order.

<Step of Processing Base Plate 10A>

In the first recording medium supplying step, the supplying device 20 suctions the base plate 10A on the top of the pile of the multiplicity of base plates in the supply stacker 21 with the suction unit 22A of the base plate transfer unit 22 and transfers the base plate 10A onto the table 24F of the positioning unit 24. Then, the positioning unit 24 positions the base plate 10A at the above-described predetermined base plate supplying position. After then, the transfer unit 25 transfers the base plate 10A positioned at the above-mentioned base plate supplying position to the X table 32 of the measuring device 30. Consequently, the base plate 10A is supplied to the measuring device 30.

In the above-mentioned recording medium supplying step, when the base plate 10A is transferred from the positioning unit 24 to the measuring device 30, the operation of the vibration-isolating unit 70A is prohibited. Then, the base plate 10A is transferred to the predetermined position on the X table 32 of the measuring device 30 while the operation of the vibration-isolating unit 70A is prohibited.

Next, in the first measuring step, the measuring device 30 measures the positions of the position measuring marks 12 and the positions of the image recording standard marks 11 on the above-mentioned base plate 10A supplied by the supplying device 20 with the camera 39. The positional relationship obtaining unit 37 obtains positional relationship data indicating a positional relationship between the two and stores the data.

In the above-mentioned first measuring step, the vibration-isolating unit 70A is actuated.

Next, in the transferring step, the transfer device 40 transfers the base plate 10A from the measuring device 30 to the X table 52 of the recording device 50.

During the above-mentioned transferring step, operation of the vibration-isolating unit 70A and the vibration-isolating unit 70B is prohibited.

In the second measuring step following the transferring step on the above-mentioned base plate 10A, the recording device 50 measures the positions of the position measuring marks 12 on the base plate 10A which has been transferred to the above-mentioned X table 52 with respect to the recording device 50 with the two cameras 59C. The position data obtaining unit 57A obtains position data representing the positions and stores the data.

During the above-mentioned second measuring step, the vibration-isolating unit 70B is actuated.

Next, in the standard mark position obtaining step, the standard mark position setting unit 57B of the recording device 50 obtains the positions of the image recording standard marks with respect to the recording device 50 based on the positional relationship data obtained in the above-mentioned first measuring step and the position data obtained in the above-mentioned second measuring step.

Next, in the image data correcting step, the image data correcting unit 57C of the recording device 50 corrects the image data representing the image pattern based on the positions of the image recording standard marks, obtained in the standard mark position obtaining step so that the image pattern recorded in the image data recording unit 57D is recorded on the above-mentioned base plate 10A.

Next, in the recording step, the recording device 50 records the image pattern represented by the image data on the base plate 10A by using the image data corrected by the above-mentioned image data correcting unit 57C.

During the above-mentioned recording step, the vibration-isolating unit 70B is actuated.

In the recording medium retrieving step following the recording step on the above-mentioned base plate 10A, the retrieving device 60 retrieves the base plate 10A on which the above-mentioned image pattern is recorded from the recording device 50.

<Step of Processing Base Plate 10B>

When the first measuring step on the above-mentioned base plate 10A starts, the recording medium supplying step is carried out on the base plate 10B in parallel with the first measuring step. Specifically, the supplying device 20 suctions the base plate 10B following the preceding base plate 10A, on the top of the supply stacker 21 with the suction unit 22A of the base plate transfer unit 22 and transfers the base plate 10B onto the table 24F of the positioning unit 24. Then, the positioning unit 24 positions the base plate 10B at the above-described predetermined base plate supplying position. After then, the transfer device 40 removes the base plate 10A from the measuring device 30 for transferring the base plate 10A from the measuring device 30 to the recording device 50. Then, the base plate transfer unit 25C of the supplying device 20 transfers the base plate 10B from the positioning unit 24 to the measuring device 30.

During the above-mentioned recording medium supplying step, when the base plate 10B is transferred from the positioning unit 24 to the measuring device 30, the operation of the vibration-isolating unit 70A is prohibited.

Next, when the second measuring step on the above-mentioned base plate 10A is started by the recording device 50, the first measuring step on the above-mentioned base plate 10B is carried out by the measuring device 30.

While the above-mentioned first measuring step is carried out, the vibration-isolating unit 70A is actuated.

When the recording step on the base plate 10A by the recording device 50 ends and the base plate 10A is retrieved by the retrieving device 60, the transfer device 40 carries out the transferring step of transferring the base plate 10B from the measuring device 30 to the recording device 50.

During the above-mentioned transferring step, the operation of the vibration-isolating unit 70A and the vibration-isolating unit 70B is prohibited.

Thereafter, when the recording device 50 completes the second measuring step through the recording step on the base plate 10B, the retrieving device 60 retrieves the base plate 10B.

During the above-mentioned second measuring step and recording step, the vibration-isolating unit 70B is actuated.

<Step of Processing Base Plate 10C>

When the first measuring step on the above-mentioned base plate 10B starts, the recording medium supplying step is carried out on the base plate 10C, in parallel with the first measuring step of the base plate 1DB. Specifically, the supplying device 20 suctions the base plate 10C following the base plate 10B, on the top of the supply stacker 21 with the suction unit 22A of the base plate transfer unit 22 and transfers the base plate 10C onto the table 24F of the positioning unit 24. Then, the positioning unit 24 positions the base plate 10C at the above-mentioned predetermined base plate supplying position.

As described above, the measuring device 30 can carry out the first measuring step on the next base plate 10 in parallel with one or a plurality of steps among the second measuring step, the standard mark position obtaining step, the image data correcting step and the recording step on the preceding base plate 10 by the recording device 50. Therefore, even if time for measuring on the base plate 10 increases, the drop in the total productivity in processing the plurality of base plates 10 can be prevented.

1. An image pattern recording method for recording an image pattern on a recording medium having a position measuring mark, for measuring a position of the recording medium, and an image recording standard mark, which is a standard position for recording the image pattern when the image pattern is recorded on the recording medium, arranged thereon, the method comprising the steps of:
supplying the recording medium to a measuring device with a supplying device;
performing a first measurement with a measuring device to obtain positional relationship data indicating a positional relationship between a position of the position measuring mark and a position of the image recording standard mark on the recording medium supplied to the measuring device;
transferring the recording medium from the measuring device to a recording device with a transferring device;
performing a second measurement with the recording device to obtain position data representing a position of the position measuring mark on the recording medium, with respect to the recording device, transferred to the recording device;
obtaining a position of the image recording standard mark with respect to the recording device with the recording device, based on the positional relationship data obtained in the first measuring step and the position data obtained in the second measuring step;
correcting image data representing the image pattern with the recording device so that the image pattern is recorded on the recording medium based on the position of the image recording standard mark, obtained in the standard mark position obtaining step; and
recording an image pattern represented by the corrected image data on the recording medium with the recording device using the corrected image data, wherein all of the steps are carried out in this order, wherein the first measurement by the measuring device is carried out on a next recording medium, which is supplied to the measuring device, following the preceding recording medium in the recording medium supplying step, in parallel with one or a plurality of the second measuring step, the standard mark position obtaining step, the image data correcting step and the recording step on the preceding recording medium by the recording device.

2. An image pattern recording method as defined in claim 1, wherein: the measuring device and the transfer device are connected by a vibration-isolator; the positional relationship between the measuring device and the transfer device is fixed by prohibiting operation of the vibration-isolator when the recording medium is removed from the measuring device by the transfer device; and the vibration-isolator is actuated when the first measuring step is carried out by the measuring device, and wherein: the transfer device and the recording device are connected by a vibration-isolator; the positional relationship between the transfer device and the recording device is fixed by prohibiting operation of the vibration-isolator when the recording medium is transferred to the recording device by the transfer device; and the vibration-isolator is actuated when the second measuring step or the recording step is carried out by the recording device.

3. An image pattern recording method as defined in claim 1, wherein the position measuring mark is also used as the image recording standard mark.

4. An image pattern recording method as defined in claim 2, wherein the position measuring mark is also used as the image recording standard mark.

5. An image pattern recording method as defined in claim 1, further comprising the step of:
controlling each of a temperature of a table for holding the recording medium supplied to the measuring device and a temperature of a table for holding the recording medium transferred to the recording device to be constant.

6. An image pattern recording method as defined in claim 2, further comprising the step of:
controlling each of a temperature of a table for holding the recording medium supplied to the measuring device and a temperature of a table for holding the recording medium transferred to the recording device to be constant.

7. An image pattern recording method as defined in claim 3, further comprising the step of:
controlling each of a temperature of a table for holding the recording medium supplied to the measuring device and a temperature of a table for holding the recording medium transferred to the recording device to be constant.
